(19) United States
(12) Patent Application Publication
(10) Pub. No.: US 2004/0125120 A1
(43) Pub. Date: Jul. 1, 2004

(54) Method and apparatus for interactive transmission and reception of tactile information

(76) Inventor: Michael Weiner, Webster, NY (US)

Correspondence Address: SIMPSON & SIMPSON, PLLC, 5555 MAIN STREET, WILLIAMSVILLE, NY, 14221-5406, US

(21) Appl. No.: 10/297,508

(22) PCT Filed: Jun. 8, 2001
(86) PCT No.: PCT/US01/18495

(51) Int. Cl. G09G 5/00

(52) U.S. Cl. 345/701

(57) ABSTRACT

An apparatus and method for interactive transmission and reception of tactile information, comprising means for creating a signal representative of a human tactile event, means for transmitting the signal to a remote recipient, and, means for decoding the signal in a manner which conveys tactile information to a recipient.

### TECHNICAL FIELD

The present invention relates generally to computers, multimedia, robotics and sensory devices, and, more particularly, to a method and apparatus for interactive transmission and reception of tactile information.

### BACKGROUND ART

Computers are becoming more and more ubiquitous in our daily lives, and assuming more and more functionality, from business to entertainment. Computer interaction with humans still lags far behind interpersonal, interactive human experience. One obvious shortcoming is that computers do not ordinarily touch human beings. Humans typically interact with computers by typing at a keyboard, or by manipulating a mouse or other pointing device, to direct the computers to perform tasks.

Recently, a mouse was introduced to the market that provides tactile feedback, providing the sense of physical movement and vibration to the user in the form of the mouse. Steering wheels and joysticks with tactile feedback for playing video games (such as race car driving) have also been recently introduced. Motion picture studios sometimes include hydraulic devices to augment feelings of inertia and movement.

When humans meet, and particularly when humans convey feelings such as affection, love, comfort, they frequently use the sense of touch to do so. Computers, telephones, television sets and other inanimate objects do not convey feelings using the sense of touch, and heretofore it has generally not been imagined that they could do so.

As humans continue to travel and move away from their families, and as computer connectivity proliferates, methods of adding human tactile feedback to computer interaction can add greatly to the interactive experience.

Consider, for example, the bedridden invalid whose son or daughter calls (or e-mails) from a remote site, perhaps a ship at sea, or, in the future, a space station or remote planet. The conveyance of the message, “I love you, Mom,” would, in person, often involve a stroke of the cheek or hair, a touch on the arm, a soft hand on the back, a hand placed on the back of a hand. Computers presently do not facilitate this tactile conveyance of emotion.

Further, lovers separated by long distances may engage in simulated affections and even sexual stimulation, primarily engaging voice, words, and visuals, within the capacity of the available means of today's computing systems. While this is a controversial use of computers, it appears to be a popular one. The interactive experience, whether communicative, sensual, affectionate, loving, or sexual, would clearly be enhanced by the same loving touch, gentle stroke, or other tactile conveyance.

The problem is that computers today, for the most part, start and stop on dimensions primarily involving screen interaction and/or audio interaction.

There is clearly a need, then, for integrated, interactive, means of tactile communication.

We see the first indications of this need in the prior art in the form of “telepresence.” DARPA has funded exciting methods for remote operative surgery, so the skilled surgeon can actually wield the scalpel and the suture on a patient in a remote battlefield or a ship at sea. But not so the loving touch or the gentle caress that mother and son, or lovers, would wish to impose on one another if separated.

The extension of interactive tactile methods can eventually apply to many media, including CD-ROM, television, motion pictures, the Internet, telephone, etc.

For this to occur we will need devices that are dependable, affordable, perform a reasonable degree of simulation of the human tactile touch, and share a common protocol of interactive commands, so the devices of multiple manufacturers can plug and play with one another. We need for a touch to remain a touch and not turn into a punch, or a push, due to some system snafu or protocol problem. We want to adapt the technology so that we do not run into the unfortunate problem that a child away at college is unable to give grandma a hug and stroke on the cheek because the systems do not interact.

The sexual aspect of human interaction remains one of great controversy. Yet the sexual use of the Internet is reported to be one of the more popular pursuits. In an age of sexually transmitted disease, the availability of computer interaction that can also convey a gentle human touch and a common protocol provides a potentially valuable option for partners separated by long distances, and for those who wish to practice abstinence.

We acknowledge that technology and the ethics and moral values of different technologists may frequently be out of synch. Whether or not an individual approves of, or elects to use, this aspect of human tactile interactive tools, the means to do so have thus far not been effectively developed or deployed. This invention seeks to pave the way for all methods of interactive human tactile communications, working in conjunction with standard computers and networks.

During the early 1900's efforts to create player-pianos which replicated the exact sound, expression and tonal range of human pianists were tried, and the results debated. For years it was believed that a true replication of the player piano was not possible. Time and effort, however, gave way to systems such as the Ampico and the Duo-Art, which faithfully reproduce the playing of the original human artists in such a way that, when the reproduction was played to a large audience of music critics, the difference could not be detected between the human pianist and the machine simulation.

We anticipate that the ability of humans to create simulation robotics that replicate the touch of the human will increase dramatically over time. To a human immersed in a virtual reality system, seeing the face and hearing the voice of a loved one, the gentle touch, given at just the same time and with just the same duration and pressure of the remote loved one, will add dramatically to the overall human interactive experience, and as systems improve, the degree of reality, and emotional value, will grow with the technology. Similarly, to the human enmeshed in a virtual reality situation in which a lover emerges and makes love to the user, the feeling of touch will hopefully enhance the experience.

Similarly, as with the kiss, the caress, and the more intimate aspects of human interaction, such as lovemaking, the same set of objectives can add dramatically to these experiences as well. As with other forms of human sexual communications and practices, these are often private matters and of much greater and higher value when practiced within the confines of a loving relationship, such as marriage. The graphical detail often demeans the spiritual aspect of sexuality, and brings to the description of aspects of this invention a delicate challenge for the inventor, vis-à-vis the teachings required under the patent law. We will attempt to move forward with delicate care, and the proper degree of balance.

In any human interaction, both the timing and the selection of the specific tactile communication chosen has great meaning, and is often part of the unique signature of the personality of the communicator, within the context of the relationship, at that moment in time. The lover whose caress continues after the orgasm, for example, is often cited in literature and in discourse as an excellent lover. What is needed is the means to facilitate all these aspects of successful interactivity, and replication of all the subtleties of the interaction, including tactile pressure, duration, graduation, and most importantly, the exact timing and integration with other critical dynamics: the words, the tone, the timing, integrated with other aspects of visual and audio experience.

### DISCLOSURE OF INVENTION

The present invention broadly comprises a method for interactive transmission and reception of tactile information, including the steps of creating a signal representative of a human tactile event, transmitting the signal to a remote recipient, and, decoding the signal in a manner which conveys tactile information to a recipient. The invention also includes an apparatus for implementing the method of the invention.

### BRIEF DESCRIPTION OF DRAWINGS

FIG. 1 is a block diagram and flow chart of the method of the present invention;

FIG. 2 is a time-line illustrating an example of synchronized sensory packages;

FIG. 3 is a diagram that indicates the individual instruction components of a typical sensory package; and,

FIG. 4 is a timing diagram for the editing and composition aspect of the present invention.

### BEST MODE FOR CARRYING OUT THE INVENTION

There is a need for systems and methods of connecting computers to devices for the purposes of a wide variety of extensions of human interaction, between humans, and for the programmable method of conveying human tactile information, in conjunction with other programs and communications methods.

The nature of the intended human interactions may vary widely from moment to moment, and from application to application. They range from the loving touch of a grandparent, sent to a grandchild while on the telephone or over the Internet if a live communication, to an archival message to subsequent generations of great grandchildren preserved for posterity.

At the essence of the approach, several critical factors are relevant:

a) the intended human action, once perceived or captured, on the computer, needs to be preservable in a software program command that enables it to be stored, forwarded, interpreted, and transmitted;

b) the intended human action needs to be recorded in actual execution, or created in software command that simulates the action, once stored;

c) the intended human action needs to be transmitted from the computing device of the sender, to the computer device of the receiver;

d) the intended human action needs to be conveyed to a mechanical or other form of (such as biometric, organic, etc.) device capable of simulating the intended human action, such as the touch, the caress, the pat, massage, etc.;

e) the intended human action needs to be replicable by a mechanical or electrical device that simulates the intended human action;

f) there needs to be a set of system commands that enable varying computers, connectivity means, devices, etc., to emulate the same or a similar output, based on the originating input or the command that is given.

The present invention combines both the mechanics of the touch, or stroke, or other mechanics, with the artistic aspects of exactly who does what, and when, and how. It provides a command language that provides a macro form of storing the complex interactions that might be required to command a “light pat on the back,” or “a gentle touch on the arm.” (And to avoid the unintentional loss of one's teeth or the knocking of air out of one's lungs.)

In the prior art, virtual reality systems have comprised remote medical surgical procedures, and three-dimensional virtual worlds. In the surgical art, a surgeon can view a patient, manipulate instruments remotely, and receive tactical feedback from resistance such as bone and skin. The remote device is generally an instrument or a probe, and works on a patient who would likely have been anaesthetized. In the virtual reality game, the user generally interacts with a fictitious world.

In this invention, the user uses robotic control to send tactile actions and messages to another human, with the intent for that human to sense the tactile, and in certain instances, for that user to respond with tactile data. We are adding to the interactive world of computing interactive touch, to augment interactive text, sound, and video.

Our invention also teaches the incorporation of olfactory senses.

A software program managing a multi-media communication, whether live, recorded, simulated, or stored, embeds a command and plurality of parameters in a signal that is transmitted to a recipient. Upon receipt, the system decodes/demodulates the signal and causes a variety of devices to simulate a tactile human event that is perceived by a human interacting with a computer or communications device.

The embedded commands may be communicated interactively in real time, or stored in an intermediary form such as CD-ROM or a hard disk that allows the transmitted tactile communication to be received at a later point of time, whether milliseconds later or centuries later, which incorporates the tactical message interposed within the context of the rest of the message, be it audio, typographic, video, animated, or a combination thereof.

For the specific embodiment we will use the example of a recorded message from a family to their invalid grandmother being cared for in a hospital facility. The recorded message is attached to an electronic mail message, sent to the hospital administrator, who arranges for it to be played for the patient at her bedside.

The tactile recording device (1) used in this example is a virtual reality glove, or similar device, equipped with electrodes which enable recording of the movements and tactile pressures of a human hand (2). The glove is linked to the recording computer (3) by means of a connecting devices such as a cable or wireless connector (4). The recording computer (3) used in this example is a personal computer as of the type generally deployed today, with a Windows operating system, running a multi-media recording software such as Macromedia.

A series of commands facilitates the capturing of the specific tactile device in use (the glove). The commands recorded from the glove are recorded and inserted in a file that can be combined or integrated into the Macromedia software's recording, either as a textual command or inserted into the graphics or sound file in such a way as to be retrieved and used on the receiving end to play back both the entire multi-media session and the additional aspects of the tactile device data stream, so as to synchronize the tactile message within the context of the rest of the message.

In another instance, the glove and the recording of the glove's movements can be given by a user who types a command, such as “gentle touch, arm.” The software program will provide the necessary commands, based on this input, to generate a gentle touch on the arm by the receiving robotic device capable of acting on this command.

The combined data stream is then communicated to a receiving device at another computer, or stored on media that enable the combined message to be retrieved and replayed on any computing device, including the originating device, or transmitted by any means to a remote device, and played back in real time or stored for subsequent replay, or both.

On the receiving side of the combined message we parse out the tactile digital information and enable the processor to direct it to the port or other connection means where the tactile implementation device (output) can be applied. In our example, the message is parsed out of the greater message and played back using a software program (5) which converts the software encoding to a series of command lines interpretable by the tactile implementation device, which results in a series of actions which simulate the originating tactile message.

In our example of a glove recording the parameters of a human hand caressing the cheek of a loved one, we have a robotic device on the receiving end which simulates the movement and tactile pressure of the glove in such a fashion as to have the recipient feel the touch at the precise moment, in relationship to the sound and image it is being played back with (or in real time if the interactive session is being conducted in real time). The specific embodiment of the tactile communicator in this instance can be a robotic arm that can emulate movement and pressure of the robotic glove on the transmission side.

Those familiar with the art of robotic gloves and other devices know the specific methods of recording the biometric indicators of the input device, and those skilled in the art of robotics know how to replicate a robotic arm to duplicate the movement and pressure of the originating input device.

It is our simultaneous inclusion in the greater audio-visual message of this information, the parallel transmission and interpretation of it, and the ability of the human sender or author to create a message that incorporates these mechanics as a subset of the overall communication which is being taught.

A language is needed to incorporate the telemetry of one or more tactile communicating devices within the greater context of audio-visual multi-media communications, to enable a concise and interpretable means of inputting, recording, transmitting, receiving, and replicating, the tactile message within the context of the greater message.

The language includes the type, make, serial number, if applicable, parameters, timing, and actions recorded (or transmitted in real time) of the sending system, so that, when interpreted on the receiving end the information can be parsed out of the greater message and directed to the appropriate device(s) on the receiving end. A specific multi-media interactive session might include more than one tactile simulator.

The specific encodings and command parameters of differing devices used for tactile communicators may vary. We envision a series of connectors, converters and interpolators that convert the recordings of one input device into related simulations of actions on the output side, potentially with a different device using different simulators and commands.

A connecting device may be needed between the computer's ports and the tactile communicator to facilitate connecting different connectors, voltages, commands, transmission protocols and voltages, etc.

Prosthetic input devices on the transmission side, and their corresponding tactile communicating devices on the receiving Robotic devices, can cover a variety of human tactile stimulations.

In the simulation of human touch, the ability to caress, massage, knead, rub, stroke, wash, tickle, fondle, poke, et al, are all recordable and replayable.

In the simulation of human sexuality and sexual experiences a wide variety of input devices and output devices is envisioned. A device on the market today, and demonstrated on an Internet web site takes a modified penal enlarger, as taught in U.S. Pat. No. 4,641,638, and adds a vacuum device and an interconnect device. This device includes a massage device which simulates vertical stroking motions, and is accompanied by a CD-ROM which incorporates multi-media direction, synchronized with a multi-media image of a woman, and simulating a sexual act with the wearer of the device. The CD-ROM provides a series of commands that are synchronized with the audio-visual programming.

In our invention, a user will be able to use a software command to incorporate into a communication the necessary commands to engage this type of stimulator in conjunction with an interactive session. Whatever types of actions are undertaken, programmed, or simulated by the transmitter will be communicated (or recorded and communicated later) and interpolated by the receiving device(s).

The transmitting signal may come from a combination of a) commands, b) recorded or transmitted telemetry from a transmitting recording device, c) a combination of a and b. These signals are captured by a receiving device and converted to tactile interpretable movements by a local device, which simulates the intent of the transmitter to devices on the receiving side.

In the case of sexual communications and devices, a program such as a virtual reality program may induce a multi-media situation where two partners, a male and female in this preferred embodiment, commence relations. The program may induce simulated sensory stimulation to a person in one location and a person in another, each wearing tactile transmitting devices simulating to the second person the actions of a first person (the real person), and simultaneously simulating to the second person the actions of the simulated person, all in unison. At this point in time the system may confer to the human participants control of the interaction, so that the humans are now acting as the transmitters and sending and receiving the stimulations and simulations in real time, through the connection (which may be a network, etc.).

These sessions can be recorded, facilitating playback by the participants, or allowing third parties to experience either the male or female experience at a later time.

Robotic devices designed for human tactile communications need to incorporate a combination of programmable robotics, touch sensitive feedback, and a variety of tactile surfaces and materials, such as fur, silk, finger simulators, hand/glove simulators, oral simulators, etc., software, communications, and connectivity, for the purposes of simultaneously simulating human touch, and programming the simulation with other events going on in a communications scenario.

At the heart of the recording and playback are the means of recording, storing, transmitting, capturing, and playing back of various human tactile simulations, using a variety of robotic devices, in a one way or two-way interaction.

An additional tactile sense is the sense of smell. It is desirable in certain virtual reality situations to induce, along with sight, sound and physical tactile sense, a sense of smell. For example, someone walking along the beach may wish to feel the ocean wind, hear the surf, and smell the salt air and those nautical smells we find along the shore.

By having a device that can emit olfactory output, the sense of smell, commanded by the computer when the person is placed into a nautical or ocean setting, we add to the overall tactile and immersive experience.

There are several ways to remotely induce olfactory senses.

On the receiving side, a robotic device that can either release or generate olfactory outputs is provided. A set of containers holding olfactory sense inducers, such as perfume, and other olfactory inducers, is contained and released on command from the remote computer; in another scenario the remote computer sends a command to a system which creates the molecules needed for inducing a set of smells to the user.

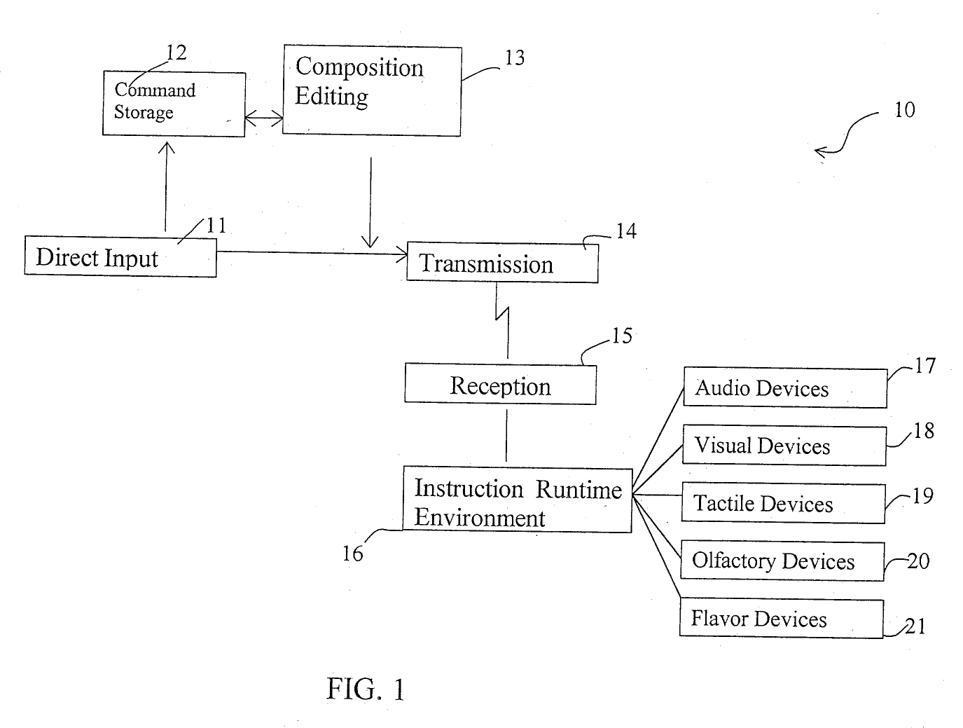

The basic building blocks of the present invention are best understood with reference to the several drawing figures. FIG. 1 illustrates the basic building blocks of the apparatus and method of the present invention. Direct input 11 may be any one of a number of devices capable of creating a tactile event and initiating a signal associated therewith. For example, direct input 11 may be a sensory glove. A wearer of the glove could create an event by shaking a hand, patting a back, petting a dog, or any number of other tactile generating events. The signals generated by this tactile event are transmitted from the direct input to command storage unit 12. The command storage unit records the sensory input for later playback, transmission, or editing. Two-way communication takes place between the command storage unit and the composition/editing unit 13. Unit 13 receives commands from unit 12 and then edits them to make them suitable for transmission. After editing, the commands are sent to transmitter 14 for transmission to a remote location. The commands are received at the remote location by receiver 15. Receiver 15, in turn, sends the commands to instruction runtime environment 16. Unit 16 contains the software and hardware necessary to interpret the commands and direct the sensory devices. The sensory devices may include any number of devices capable of receiving the command signals and generating a “tactile” response thereto. By “tactile” response, it is meant a response which stimulates one or more of the senses of hearing (via audio device 17), vision (via visual device 18), touch (via tactile device 19), smell (via olfactory device 20) or taste (via flavor device 21).

As an example, imagine the sender sends the receiver a valentine. The valentine comprises a candy rose with red petals and a green stem, complete with thorns along the stem. The valentine includes the auditory message, “I love you—enjoy the fragrance, taste and color of the rose, but be careful not to touch the thorns.” Upon receipt of the virtual valentine, the recipient, who is wearing a sensory glove, hears the message and sees a hologram or stereoscopic image of the rose in full color, and an olfactory device emits the rose's scent as well. Upon simulated touch of the rose, the petals can be plucked by the recipient and placed in her mouth, where a flavor device emits a chocolate flavor detected by the tongue of the recipient, and, the recipient feels a “prick” as she touches the thorn.

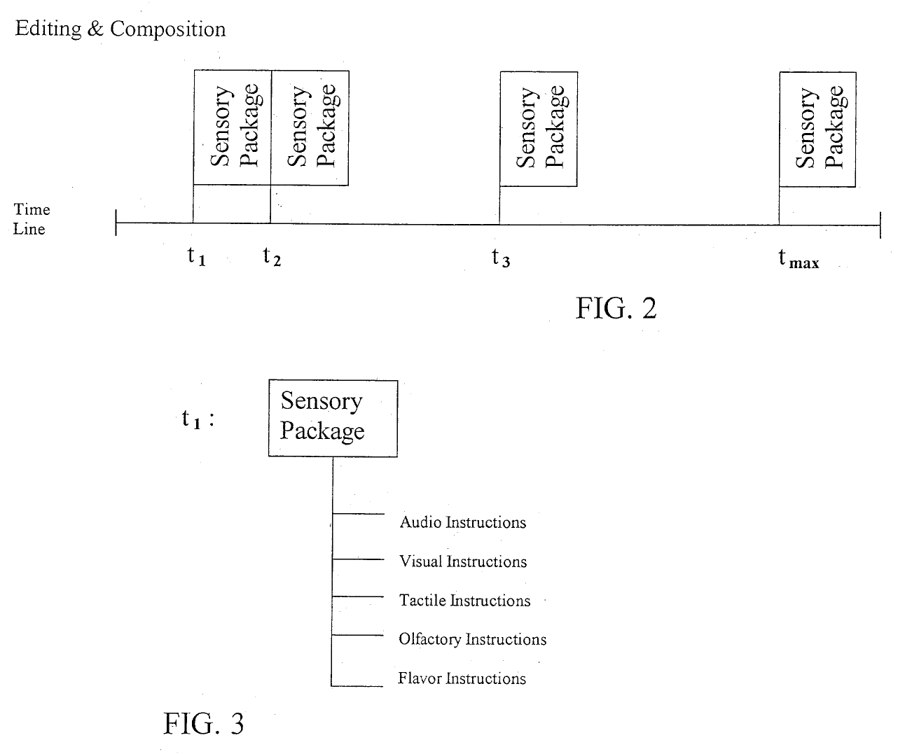

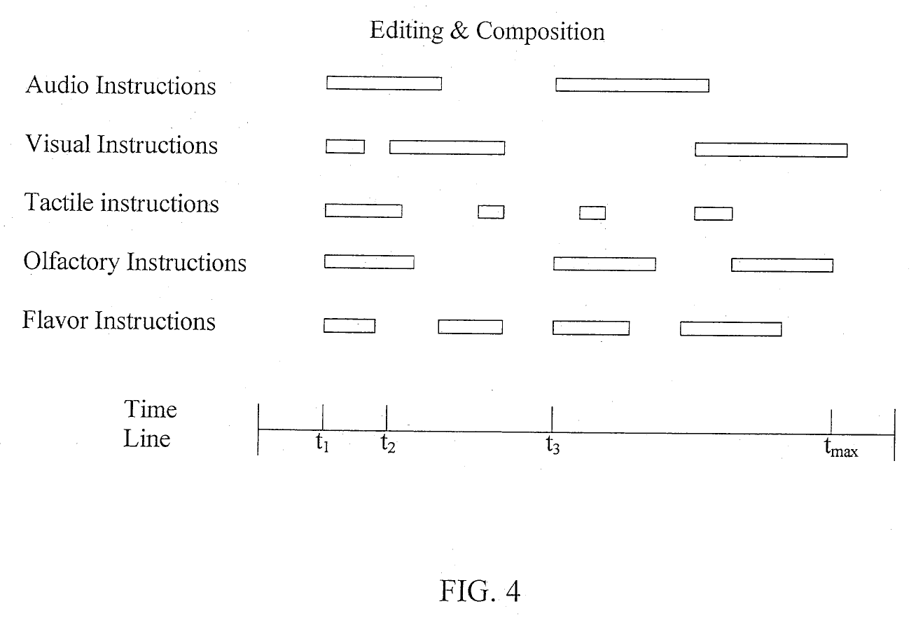

With reference to FIGS. 2, 3 and 4, the use of “morphing” between one time interval and another may be employed in transmitting the sensory packages (each of which contains a set of audio, visual, tactile, olfactory and flavor instructions). For example, a “stroke hand” command in a sensory package might include the time duration of this package, the start and end location of the stroking hand, and the pressure applied at the start and end positions. Without giving exact instructions for time periods shorter than this sensory package interval, the Runtime Environment and sensory devices must interpolate the movement for all time intervals shorter than the package time. By shortening the time interval, the stroking hand would move slower. Commands could also be created and edited in an asynchronous way. By using the above-described “morphing”, all time intervals from t₁ to tₘₐₓ can be filled in to any minimum time interval required. This approach to editing the commands/data is particularly useful for isolating and editing one sense at a time. For a particular implementation sensory development and editing environment, there would be the ability to programmatically determine the state of the other senses and to react accordingly. All sensors require a feedback mechanism. This is particularly important for staying within safety tolerances of each sense. It should be apparent to those having ordinary skill in the art that changes and modifications can be made to the invention without departing from the scope and spirit of the claims.

What is claimed is:

1) A method for interactive transmission and reception of tactile information, comprising:
a) creating a signal representative of a human tactile event;
b) transmitting said signal to a remote recipient; and,
c) decoding said signal in a manner which conveys tactile information to a recipient.

2) A method as recited in claim 1 wherein said human tactile event is selected from the group consisting of touch, taste, smell, hearing, and vision.

3) A method as recited in claim 2 wherein said signal further comprises a nonhuman tactile component.

4) A method as recited in claim 1 wherein said signal is a digital signal.

5) A method as recited in claim 1 wherein said signal is created by sensing tactile inputs of a living being and converting said sensed input into a digital signal.

6) A method as recited in claim 4 wherein said sensed inputs are stored as a digital signal.

7) A method as recited in claim 1 wherein said decoding comprises communicating said signal to a robotic device that, in turn, provides programmed tactile communication to the recipient.

8) An apparatus for interactive transmission and reception of tactile information, comprising:
a) means for creating a signal representative of a human tactile event;
b) means for transmitting said signal to a remote recipient; and,
c) means for decoding said signal in a manner which conveys tactile information to a recipient.
